(19) United States
(12) Patent Application Publication
(10) Pub. No.: US 2021/0363368 A1
(43) Pub. Date: Nov. 25, 2021

(54) INKJET INK

(71) Applicant: KYOCERA Document Solutions Inc., Osaka (JP)

(72) Inventor: Noriaki OZAWA, Osaka-shi (JP)

(73) Assignee: KYOCERA Document Solutions Inc., Osaka (JP)

(21) Appl. No.: 17/323,306

(22) Filed: May 18, 2021

(30) Foreign Application Priority Data
May 19, 2020 (JP) 2020-087486

(51) Int. Cl. C09D 11/326; C09D 17/00; C08K 3/04; C08F 212/08; C08F 220/06; C08F 220/18; C08F 222/06

(52) U.S. Cl. CPC C09D 11/326; C09D 17/001; C08K 3/04; C08F 212/08; C08K 2201/011; C08F 220/1803; C08F 220/1804; C08F 222/06; C08K 2201/003; C08F 220/06

(57) ABSTRACT

An inkjet ink includes at least pigment particles, a resin, and water. Dispersed particles in the inkjet ink including the pigment particles have an average particle diameter of at least 90 nm and no greater than 100 nm. The resin has a mass ratio to the pigment particles of at least 0.05 and no greater than 0.10. The resin includes at least a repeating unit represented by formula (1) and a repeating unit represented by formula (2). A molar ratio of the repeating unit represented by the formula (2) to the repeating unit represented by the formula (1) is at least 0.35 and no greater than 0.80. In formula (2), R¹ represents an alkyl group having a carbon number of 3 or 4

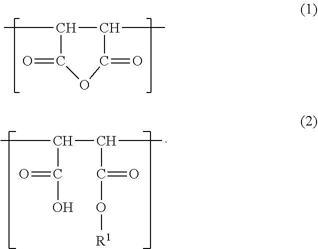

### INCORPORATION BY REFERENCE

The present application claims priority under 35 U.S.C. § 119 to Japanese Patent Application No. 2020-087486, filed on May 19, 2020. The contents of this application are incorporated herein by reference in their entirety.

### BACKGROUND

The present disclosure relates to an inkjet ink.

Images are formed on a recording medium by ejecting inkjet ink from a recording head of an inkjet recording apparatus. In image formation using a line-type recording head as the recording head, multi-pass printing is often not performed and the image density of the formed image tends to be low. It is known that an ink set that includes a water-based ink for inkjet recording and a polyvalent metal salt solution is used in order to improve the image density of the formed image. The water-based ink for inkjet recording contains a carbon black and a copolymer of (meth)acrylic acid and another copolymerizable ethylenically unsaturated monomer. A ratio (B/A) of the copolymer (B) to the carbon black (A) is at least 0.30 and no greater than 0.55.

### SUMMARY

An inkjet ink according to an aspect of the present disclosure includes at least pigment particles, a resin, and water. Dispersion particles in the inkjet ink including the pigment particles have an average particle diameter of at least 90 nm and no greater than 100 nm. The resin has a mass ratio to the pigment particles of at least 0.05 and no greater than 0.10. The resin includes at least a repeating unit represented by formula (1) and a repeating unit represented by formula (2). A molar ratio of the repeating unit represented by the formula (2) to the repeating unit represented by the formula (1) is at least 0.35 and no greater than 0.80. In the formula (2), R¹ represents an alkyl group having a carbon number of 3 or 4.

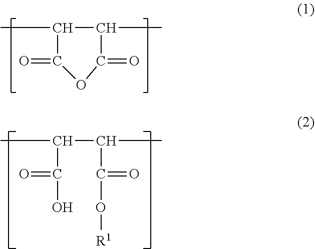

### DETAILED DESCRIPTION

Terms used in the present specification are described first. In the present specification, the phrases “increasing image density of formed images” and “improving image density of formed images” mean that “images with a desired image density can be formed”. Any one type of components described in the present specification may be used or a combination of any two or more types thereof may be used.

Measurement values for number average molecular weight (Mn) and mass average molecular weight (Mw) are values as measured using gel permeation chromatography unless otherwise stated.

An alkyl group having a carbon number of 3 or 4 and an alkyl group having a carbon number of at least 1 and no greater than 12 each are an unsubstituted straight or branched chain alkyl group unless otherwise stated. Examples of the alkyl group having a carbon number of at least 1 and no greater than 12 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, 1-1-diethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, 1,2,2-trimethylpropyl group, a 1-ethylbutyl group, a 2-ethylbutyl group, a 3-ethylbutyl group, straight and branched chain heptyl groups, straight and branched-chain octyl groups, straight and branched-chain nonyl groups, straight and branched-chain decyl groups, straight and branched-chain undecyl groups, and straight and branched-chain dodecyl groups.

Examples of the alkyl group having a carbon number of 3 or 4 are groups having a carbon number of 3 or 4 among the groups listed as examples of the alkyl group having a carbon number of at least 1 and no greater than 12. Terms used in the present specification have been described so far.

<Inkjet Ink>

The following describes an inkjet ink (also referred to below as ink) according to an embodiment of the present disclosure. The ink according to the present embodiment contains at least pigment particles, a resin, and water. The ink according to the present embodiment is a water-based ink containing water.

(Pigment Particles)

The pigment particles are dispersed in the ink. At least a portion of the resin may or may not be attached to the surfaces of the pigment particles.

The resin has a mass ratio to the pigment particles of at least 0.05 and no greater than 0.10. In the following, the “mass ratio of the resin to the pigment particles” may be also referred to below as a “resin/pigment ratio”. Here, in order to increase image density of formed images, it is effective to retain the pigment particles in a surface layer area of a recording medium (e.g., an area from the surface of a recording medium to 20 μm in its depth direction). When the resin/pigment ratio exceeds 0.10, the amount of resin attached to the surfaces of the pigment particles tends to increase, and the hydrophilicity of the pigment particles to the water contained in the ink increases. This causes the pigment particles to penetrate deeper than the surface layer area of the recording medium, resulting in demonstration of a tendency to decrease image density of formed images. When the resin/pigment ratio is less than 0.05 by contrast, the amount of resin attached to the surfaces of the pigment particles tends to decrease and the hydrophilicity of the pigment particles to the water contained in the ink decreases. Therefore, it is difficult for the pigment particles to penetrate into the surface layer area of the recording medium and the pigment particles stay on the top surface of the recording medium. As a result, scratch resistance of the formed images decreases. When the resin/pigment ratio is less than 0.05, the amount of resin attached to the surfaces of the pigment particles tends to decrease and the pigment particles in a formed image tend to collapse when scratched. This also reduces scratch resistance of the formed image. Therefore, as a result of the resin/pigment ratio being at least 0.05 and no greater than 0.10, formed images can have both image density and scratch resistance. Note that resin/pigment ratio is calculated using a formula “resin/pigment ratio=mass of resin/mass of pigment particles”.

No particular limitations are placed on pigment constituting the pigment particles. Examples of the pigment constituting the pigment particles include black pigments, white pigments, yellow pigments, orange pigments, red pigments, blue pigments, and violet pigments. Examples of the black pigments include C.I. Pigment Black 7 and carbon blacks. Examples of the white pigments include C.I. Pigment White 6. Examples of the yellow pigments include C.I. Pigment Yellow 74, 93, 95, 109, 110, 120, 128, 138, 139, 151, 154, 155, 173, 180, 185, or 193. Examples of the orange pigments include C.I. Pigment Orange 34, 36, 43, 61, 63, or 71. Examples of the red pigments include C.I. Pigment Red 122 or 202. Quinacridone Magenta (PR122) may be used as a red pigment. Examples of the blue pigments include C.I. Pigment Blue 15 or 15:3. Examples of the violet pigments include C.I. Pigment Violet 19, 23, or 33.

The pigment particles have a content ratio to mass of the ink of preferably at least 3% by mass and no greater than 30% by mass, and more preferably at least 3% by mass and no greater than 10% by mass. As a result of the content ratio of the pigment particles being at least 3% by mass, images with a desired image density can be easily obtained. As a result of the content ratio of the pigment particles being no greater than 30% by mass, an ink with excellent fluidity and excellent permeability to a recording medium can be obtained.

(Dispersion Particles)

The dispersion particles are particles dispersed in the ink. The dispersion particles include at least the pigment particles. Here, at least a portion of the resin are preferably attached to the surfaces of the pigment particles. The resin attached to the surface of the pigment particles functions as a dispersant to increase dispersibility of the pigment particles in the ink. It is possible that a portion of the resin is attached to the surfaces of the pigment particles and the rest of the resin is dispersed in the ink without being attached to the pigment particles. Alternatively, all part of the resin may be attached to the surfaces of the pigment particles. Yet, the surfaces of the pigment particles may be entirely covered with the resin or a portion of the surfaces of the pigment particles may be covered with the resin.

The dispersion particles may include only the pigment particles. In other words, the dispersion particles may be pigment particles to which the resin is not attached. The dispersion particles may further include the resin attached to the surfaces of the pigment particles in addition to the pigment particles. That is, the dispersion particles may include particles each including a pigment particle and the resin attached to the surface of the pigment particle (a resin provided on the surface of the pigment particle). In the following, “pigment particles to which the resin is not attached” may be referred to as “uncovered pigment particles”. Furthermore, “particles each including a pigment particle and resin attached to the surface of the pigment particle” may be referred to as “covered pigment particles”. The ink may contain only the covered pigment particles, only the uncovered pigment particles, or both the covered pigment particles and the uncovered pigment particles.

The dispersion particles including the pigment particles have an average particle diameter of at least 90 nm and no greater than 100 nm. When the average particle diameter of the dispersion particles is less than 90 nm, the pigment particles tend to penetrate deeper than the surface layer area of a recording medium. As a result, the image density of the formed images tends to decrease. When the average particle diameter of the dispersion particles exceeds 100 nm, the pigment particles tend to stay on top surface of a recording medium because it is difficult for the pigment particles to penetrate into the surface layer area of the recording medium. As a result, scratch resistance of formed images decreases. As such, as a result of the average particle diameter of the dispersion particles being at least 90 nm and no greater than 100 nm, formed images can have both image density and scratch resistance.

In order to improve image density and scratch resistance of formed images in a well-balanced manner, the average particle diameter of the dispersion particles is preferably at least 90 nm and no greater than 97 nm, and more preferably at least 90 nm and no greater than 93 nm.

The average particle diameter of the dispersion particles is measured in accordance with ISO 13321:1996 (Particle size analysis—Photon correlation spectroscopy). The average particle diameter of the dispersion particles can be adjusted for example by the method described later in association with <Ink Production Method>. In the above measurement, there is no distinction between the covered pigment particles and the uncovered pigment particles contained in the ink, and the dispersion particles (uncovered pigment particles and covered pigment particles) dispersed in the ink are the target of the measurement. Therefore, when both the covered pigment particles and the uncovered pigment particles are contained in the ink, an average particle diameter comprehensively measured for the covered pigment particles and the uncovered pigment particles serves as the average particle diameter of the dispersion particles.

(Resin)

The resin includes at least a repeating unit represented by formula (1) and a repeating unit represented by formula (2). A molar ratio of the repeating unit represented by the formula (2) to the repeating unit represented by the formula (1) is at least 0.35 and no greater than 0.80. In formula (2), R¹ represents an alkyl group having a carbon number of 3 or 4.

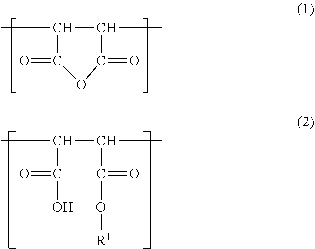

Hereafter, the “repeating unit represented by formula (1)” may be referred to as “repeating unit (1)” and the “repeating unit represented by formula (2)” may be referred to as “repeating unit (2)”. Also, the “resin including at least the repeating unit represented by formula (1) and the repeating unit represented by formula (2)” may be referred to as “predetermined resin”. Furthermore, “the molar ratio of the repeating unit represented by formula (2) to the repeating unit represented by formula (1)” may be referred to as “repeating unit ratio”.

The repeating unit (1), which is a repeating unit derived from maleic anhydride, is ring-opened and esterified (half-esterified) by an alcohol (R¹—OH) having a carbon number of 3 or 4, thereby introducing the repeating unit (2) into the predetermined resin. Hereafter, “ring-opening and esterification of a repeating unit derived from maleic anhydride by an alcohol” may be referred to as “half-esterification”.

As a result of the predetermined resin including the repeating units (1) and (2), the surface tension of an aqueous solution moderately decreases when the predetermined resin is dissolved in water. Due to effect of the predetermined resin as above, the pigment particles favorably penetrate the surface layer area of a recording medium and is difficult to stay on the top surface of the recording medium. As a result, images with excellent scratch resistance can be formed.

As a result of the predetermined resin having a repeating unit ratio of at least 0.35, an ink providing excellent scratch resistance to formed images can be obtained. As a result of the predetermined resin having a repeating unit ratio of no greater than 0.80 by contrast, image density of formed images can be improved. In order to improve image density and scratch resistance of formed images in a well-balanced manner, the repeating unit ratio is preferably at least 0.35 and no greater than 0.60.

The repeating unit ratio of the predetermined resin can be adjusted by changing the amount of an alcohol used for half esterification (alcohol for half esterification) relative to the amount of maleic anhydride in synthesis of the predetermined resin.

As previously described above, R¹ in formula (2) represents an alkyl group having a carbon number of 3 or 4. When R¹ is an alkyl group having a carbon number of no greater than 2, that is, when the alcohol used for half esterification is an alcohol having a carbon number of no greater than 2, the surface tension of an aqueous solution obtained by dissolving such a resin in water becomes excessively high. As a result, the pigment particles tend to stay on the top surface of a recording medium, and scratch resistance of formed images decreases. By contrast, when R¹ is an alkyl group having a carbon number of at least 5, that is, when the alcohol used for half esterification is an alcohol having a carbon number of at least 5, the half esterification reaction proceeds with difficulty. Therefore, when R¹ in formula (2) represents an alkyl group having a carbon number of 3 or 4, images with excellent scratch resistance can be formed with the ink and the predetermined resin can be favorably synthesized.

Preferable examples of the alkyl group having a carbon number of 3 or 4 represented by R¹ in formula (2) include an iso-propyl group and an n-butyl group.

Preferably, the predetermined resin further includes a repeating unit derived from a compound having a styrene skeleton. Examples of the compound having a styrene skeleton include styrene, o-methylstyrene, m-methylstyrene, p-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene. Styrene is preferable as the compound having a styrene skeleton.

As the repeating unit derived from a compound having a styrene skeleton, a repeating unit represented by formula (3) is preferable, and a repeating unit represented by formula (3A) is more preferable.

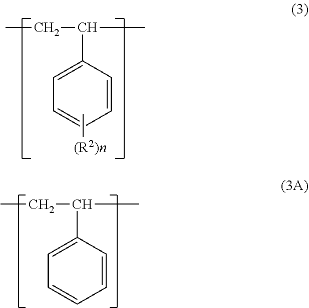

In formula (3), R² represents a phenyl group or an alkyl group having a carbon number of at least 1 and no greater than 12, and n represents an integer of at least 0 and no greater than 5. Examples of the alkyl group having a carbon number of at least 1 and no greater than 12 that may be represented by R² include a methyl group, an ethyl group, a tert-butyl group, an n-hexyl group, an n-octyl group, an n-nonyl group, an n-decyl group, and an n-dodecyl group. Preferably, n represents an integer of at least 0 and no greater than 2, and 0 is more preferable.

The molar ratio of the repeating unit derived from a compound having a styrene skeleton to the total of the repeating units (1) and (2) is preferably at least 0.5 and no greater than 1.5, more preferably at least 0.9 and no greater than 1.1, and particularly preferably 1.0. When the predetermined resin includes a repeating unit derived from a compound having a styrene skeleton, the predetermined resin may include as its repeating unit only the repeating units (1) and (2) and the repeating unit derived from a compound having a styrene skeleton. Alternatively, the predetermined resin may further include a repeating unit other than these as its repeating unit.

Preferably, the surface tension of an aqueous solution of the resin at a concentration of 10% by mass is at least 35 mN/m and no greater than 40 mN/m. In the following, the “surface tension of an aqueous solution of the resin at a concentration of 10% by mass” may be referred to as “resin surface tension”. When the resin surface tension is at least 35 mN/m, the ink containing the resin has difficulty in penetrating deeper than the surface layer area of a recording medium. As a result, image density of formed images is improved. When the surface tension of the resin is no greater than 40 mN/m, the ink containing the resin penetrates the surface layer of a recording medium moderately and has difficulty in staying on the top surface of the recording medium. As a result, images with excellent scratch resistance can be formed.

In order to improve image density and scratch resistance of formed images in a well-balanced manner, it is preferable that the resin surface tension is at least 35 mN/m and no greater than 38 mN/m.

For example, as a result of the ink containing the predetermined resin, the resin surface tension is easily adjusted to within the range of at least 35 mN/m and no greater than 40 mN/m. For example, the higher the repeat unit ratio of the predetermined resin is, the lower the resin surface tension is. For example, the lower the carbon number of the alkyl group represented by R¹ in formula (2) of the predetermined resin is, the higher the resin surface tension is. The resin surface tension is measured by the method described in association with Examples. Note that resin separated from the ink can be used for measurement of the resin surface tension.

Preferably, the predetermined resin has an acid value of at least 150 mgKOH/g and no less than 300 mgKOH/g. As a result of the predetermined resin having an acid value of at least 150 mgKOH/g, an ink with high dispersibility of the pigment particles can be obtained, and the color of formed images is excellent. When the acid value of the predetermined resin is no greater than 300 mgKOH/g, an ink with excellent preservation stability can be obtained. The acid value is measured in accordance with Japanese Industrial Standards (JIS) K0070-1992.

The ink may contain only the predetermined resin as its resin. Alternatively, the ink may contain any other resin as its resin in addition to the predetermined resin. Examples of the resin other than the predetermined resin include acrylic resin, styrene-acrylic resin, polyvinyl resin, polyester resin, amino resin, epoxy resin, urethane resin, polyether resin, polyamide resin, phenolic resin, silicone resin, fluororesin, vinyl naphthalene-acrylic acid copolymers, and vinylnaphthalene-maleic acid copolymers.

The resin has a content ratio to the mass of the ink of preferably at least 0.1% by mass and no greater than 5.0% by mass, and more preferably at least 0.3% by mass and no greater than 0.6% by mass.

(Water)

The water preferably has a content ratio to the mass of the ink of at least 40% by mass and no greater than 90% by mass, more preferably at least 50% by mass and no greater than 70% by mass, and further more preferably at least 60% by mass and no greater than 65% by mass.

(Water-Soluble Organic Solvent)

The ink may contain a water-soluble organic solvent as necessary. In the present embodiment, the water-soluble organic solvent is an organic solvent that is soluble in water and that is in a liquid state under an environmental condition at a temperature of 25° C. When the ink contains a water-soluble organic solvent, it is easy to obtain an ink having a desired viscosity.

Examples of the water-soluble organic solvent include glycol compounds, ether compounds of polyhydric alcohols, lactam compounds, nitrogen-containing compounds, acetate compounds, thiodiglycol, glycerin, 3-methyl-1,5-pentanediol, and dimethyl sulfoxide.

Examples of the glycol compounds include ethylene glycol, propylene glycol, diethylene glycol, 1,3-butanediol (i.e., 1,3-butylene glycol), 1,3-propanediol (i.e., trimethylene glycol), triethylene glycol, and tetraethylene glycol.

Examples of the ether compounds of polyhydric alcohols include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

As the water-soluble organic solvent, at least one (preferably one to three, more preferably three) selected from the group consisting of the glycol compounds, the ether compounds of polyhydric alcohols, and the lactam compounds is preferred. As the water-soluble organic solvent, at least one (preferably one to three, more preferably three) selected from the group consisting of propylene glycol, triethylene glycol monobutyl ether, and 2-pyrrolidone is more preferred.

The water-soluble organic solvent has a content ratio to the mass of the ink of at least 10% by mass and no greater than 50% by mass, and more preferably at least 20% by mass and no greater than 40% by mass.

(Surfactant)

The ink may contain a surfactant as necessary. When the ink contains a surfactant, an ink with excellent wettability to a recording medium can be obtained.

Examples of the surfactant include anionic surfactants, cationic surfactants, nonionic surfactants, and zwitterionic surfactants.

A preferable surfactant is a nonionic surfactant. The nonionic surfactant is preferably a surfactant having an acetylene bond, and is more preferably a surfactant having an acetylene glycol structure or an acetylene alcohol structure. The surfactant preferably has an HLB value of at least 3 and no greater than 20, and more preferably at least 6 and no greater than 16. The HLB value of the surfactant is calculated for example by the Griffin method from a formula “HLB value=20×(sum of formula weights of hydrophilic portion)/molecular weight”.

A preferable example of the surfactant is an ethylene oxide adduct of acetylene glycol with an HLB value of at least 8 and no greater than 10. Another preferable example of the surfactant is a surfactant having an acetylene bond with an HLB value of at least 13 and no greater than 14.

In order to improve image density of formed images while reducing image offset, the content ratio of the surfactant to the mass of the ink is preferably at least 0.1% by mass and no greater than 10.0% by mass, and more preferable at least 0.1% by mass and no greater than 1.0% by mass.

(Other Components)

The ink may contain any component other than the components previously described (specific examples include a solution stabilizer, a moisturizing agent, a penetrating agent, and a viscosity modifier) as necessary.

<Ink Production Method>

An example of a method for producing the ink of the present embodiment will be described next.

(Pigment Dispersion Preparation)

A pigment dispersion is prepared first. In detail, the resin, the pigment particles, water, and an optional component to be added as necessary (specific examples include a water-soluble organic solvent, a surfactant, a solution stabilizer, a moisturizing agent, a penetrating agent, and a viscosity modifier) are mixed together using a media disperser to obtain a pigment dispersion containing the pigment particles. Preferably, the media disperser is of a wet type. Examples of the media disperser include a sand mill, a ball mill, a roll mill, a bead mill, a Nanomizer, and a homogenizer.

A bead mill is preferable as the media disperser because it is easy to adjust the average particle diameter of the dispersion particles in the ink within a specific range. Specific examples of the bead mill include Nano Grain Mill produced by ASADA IRON WORKS. CO., LTD., MSC Mill produced by Nippon Coke & Engineering Co., Ltd., and DYNO (registered Japanese trademark) MILL produced by Willy A. Bachofen AG. Beads used in the bead mill preferably have a diameter of at least 0.5 mm and no greater than 1.0 mm. Furthermore, zirconia beads are preferable as the beads. The smaller the diameter of the beads used is, the smaller the average particle diameter of the dispersion particles is. Also, the smaller the diameter of the beads used is, the larger the amount of resin attached to the surfaces of the pigment particles is.

Furthermore, the larger the number of dispersion is, the smaller the average particle diameter of the dispersion particles is. The number of dispersion will be described later in association with Example.

(Ink Preparation)

Next, using a stirrer, the resultant pigment dispersion is mixed with water and an optional component to be added as necessary (specific examples include a water-soluble organic solvent, a surfactant, a solution stabilizer, a moisturizing agent, a penetrating agent, and a viscosity modifier) to obtain a mixed liquid. The obtained mixed liquid is filtered as necessary. In this manner, the ink is obtained. The method for producing the ink of the present embodiment has been described so far.

### EXAMPLES

Examples of the present disclosure will now be described. In the following, “mass part” may be referred to as “part” and “% by mass” may be referred to as “wt %”. The following first describes methods for measuring a surface tension of an aqueous solution of a resin and an average particle diameter of dispersion particles, which are measured in the following examples.

[Surface Tension Measuring Method]

An aqueous solution of a resin was obtained by dissolving the resin in ion exchange water so that the concentration of the resin was 10 wt %. Under an environmental condition at a temperature of 25° C., the surface tension of the resultant aqueous solution of the resin was measured by the Wilhelmy plate method (plate method) using a surface tensiometer (“Automatic Tensiometer DY-300”, product of Kyowa Interface Science Co., Ltd.).

[Average Particle Diameter Measuring Method]

A measurement sample was obtained by diluting a pigment dispersion with ion exchange water 300 times. The average particle diameter of the dispersion particles contained in the measurement sample was measured in accordance with ISO 13321:1996 (Particle size analysis—Photon correlation spectroscopy) using a laser diffraction particle size distribution analyzer (“ZETASIZER NANO Z”, product of Malvern Instruments Ltd.). Note that measurement results are the same regardless of whether a pigment dispersion or an ink is used as a measurement target.

In the following, the effect on image density and scratch resistance of formed images was examined using inks in which the average particle diameter of dispersion particles, the resin/pigment ratio, the repeating unit ratio and type of the resin, and the alcohol for half esterification used in preparation of the resin were each changed.

[Study on Average Particle Diameter of Dispersion Particles]

Inks (A-1) to (A-3), (B-1), and (B-2) containing dispersion particles with different average particle diameters were prepared by the following method. The compositions of these inks are shown in Table 4 below.

<Preparation of Ink (A-1)>

(Preparation of Resin (R-A))

First, a resin (R-A) was prepared. The composition of the resin (R-A) is shown in Table 1.

TABLE 1

| | ST-MA | | | | | Surface |
|---|---|---|---|---|---|---|
| | copolymer | 1-Butanol | 2-Propanol | Ethanol | Unit | tension |
| Resin | [part] | [part] | [part] | [part] | ratio | [mN/m] |
| R-A | 82 | 18 | — | — | 0.51 | 38 |

In Table 1, and Tables 7 and 10 below, “ST-MA copolymer” indicates styrene-maleic anhydride copolymer, “unit ratio” indicates repeating unit ratio, and “surface tension” indicates resin surface tension. In Table 1, and Tables 7, 9, and 10 below, “-” indicates that no corresponding component is contained or that there is no corresponding value.

The resin (R-A) was synthesized by the method described below. In detail, a reaction tank equipped with a gas inlet pipe, a condenser, a stirring impeller, and a thermometer was prepared. Into the reaction tank, 82 parts of a styrene-maleic anhydride copolymer (“SMA (registered Japanese trademark) 1000”, product of Cray Valley, molar ratio of styrene/maleic anhydride=1/1), 18 parts of 1-butanol, and 0.2 parts of a strong base (1,8-diazabicyclo[5.4.0]-7-undecen) were added, and the resultant mixture was heated at 110° for 8 hours. Through the above, a portion of a repeating unit derived from the maleic anhydride of the styrene-maleic anhydride copolymer was half-esterified by 1-butanol. Next, the contents of the reaction tank were cooled. The contents of the reaction tank were heated to 130° C. to evaporate water. Through the above, the resin (R-A) was obtained.

The obtained resin (R-A) included a repeating unit derived from styrene, a repeating unit derived from maleic anhydride, and a repeating unit derived from maleic anhydride esterified by 1-butanol. Table 1 shows the ratio between the repeating unit derived from maleic anhydride (corresponding to the repeating unit (1)) and the repeating unit derived from maleic anhydride esterified by 1-butanol (corresponding to the repeating unit (2)) in the resin (R-A). The resin surface tension of the resin (R-A) is also shown in Table 1.

(Pigment Dispersion Preparation)

Next, a pigment dispersion with a dispersion formulation A shown in Table 2 was prepared.

TABLE 2
Dispersion formulation A

| | | |
|---|---|---|
| Water | [wt %] | 83.3 |
| Resin | [wt %] | 1.2 |
| Pigment | [wt %] | 15.0 |
| Olfine | [wt %] | 0.5 |
| Total | [wt %] | 100.0 |

In the dispersion formulation A shown in Table 2, the resin/pigment ratio was 0.08. Furthermore, in preparation of the pigment dispersion used for the ink (A-1), the resin (R-A) was used as “Resin” indicated in the dispersion formulation A. In Table 2 and Tables 3, 5, and 8 below, “Water” indicates ion exchange water. In Table 2 and Table 5 below, “Olfine” indicates “OLFINE (registered Japanese trademark) E1010” produced by Nissin Chemical Industry Co., Ltd.

The pigment dispersion used for the ink (A-1) was prepared by the following method. In detail, ion exchange water, the resin (R-A), a pigment (C.I. Pigment Blue 15:3), a surfactant (ethylene oxide adduct of acetylenediol, “OLFINE (registered Japanese Trademark) E1010”, product of Nissin Chemical Industry Co., Ltd.) were mixed at a ratio shown as the dispersion formulation A in Table 2 to obtain a mixed liquid. A vessel charged with beads (zirconia bead) at a filing rate of 80% was set in a bead mill (“DYNO (registered Japanese trademark) MILL, product of Willy A. Bachofen AG). The resultant mixed liquid was caused to flow into the vessel at a flow rate of 250 g/minute and was then collected. In the following, the above operation of causing the flowing of and collecting the mixed liquid is referred to as prescribed operation, and the number of times the prescribed operation is performed is referred to as the number of dispersion. The prescribed operation was performed under conditions shown in a column for the Ink (A-1) in Table 4 below. In detail, the prescribed operation was performed using beads with a bead diameter of 0.5 mm under a condition that the number of dispersion is 2. After the prescribed operation, the collected mixed liquid was filtered using a membrane filter with an opening of 5 μm to obtain a pigment dispersion. The dispersion particles contained in the pigment dispersion had an average particle diameter as shown in the column for the ink (A-1) in Table 4 below.

Note that an alkaline-soluble resin in which the resin (R-A) was neutralized using potassium hydroxide was used in the preparation of the pigment dispersion. The neutralization using potassium hydroxide was performed by equivalent neutralization with an aqueous KOH solution at 105 wt %. The amount of the KOH was calculated based on mass of the resin (R-A) to be neutralized. Note that mass of ion exchange water in Table 2 includes mass of the water included in the aqueous KOH solution and mass of water produced by the neutralization reaction.

(Ink Preparation)

The ink (A-1) was prepared at an ink formulation 1 shown in Table 3.

TABLE 3
Ink formulation 1

| | | |
|---|---|---|
| Pigment dispersion | [wt %] | 40.0 |
| Triethylene glycol monobutyl ether | [wt %] | 5.0 |
| 2-Pyrrolidone | [wt %] | 5.0 |
| Propylene glycol | [wt %] | 20.0 |
| Olfine | [wt %] | 0.3 |
| Water | [wt %] | Rest |
| Total | [wt %] | 100.0 |

In the preparation of the ink (A-1), the pigment dispersion obtained in (Pigment Dispersion Preparation) described above was used as the pigment dispersion shown in Table 3. In Table 3 and Table 8 below, “Olfine” indicates “OLFINE (registered Japanese trademark) E1010” produced by Nissin Chemical Industry Co., Ltd. (ethylene oxide adduct of acetylenediol). In Table 3 and Table 8 below, “Rest” indicates an amount obtained by subtracting the amount of components other than ion exchange water from 100.0 wt % that is the total amount of the ink.

Using a stirrer, the pigment dispersion obtained in (Pigment Dispersion Preparation) described above, triethylene glycol monobutyl ether, 2-pyrrolidone, propylene glycol, a nonionic surfactant (“OLFINE (registered Japanese trademark) E1010”, product of Nissin Chemical Industry Co., Ltd., ethylene oxide adduct of acetylenediol), and ion exchange water were mixed at a ratio shown in Ink formulation 1 in Table 3 to obtain a mixed liquid. Next, the obtained mixed liquid was filtered using a membrane filter with an opening of 5 μm to obtain the ink (A-1).

<Preparation of Inks (A-2), (A-3), (B-1), and (B-2)>

Inks (A-2), (A-3), (B-1), and (B-2) were prepared according to the same method as that for preparing the ink (A-1) in all aspects other than that the prescribed operation was performed the number of dispersion shown in Table 4 using beads with a bead diameter shown in Table 4 in (Pigment Dispersion Preparation) described above. The average particle diameters of the dispersion particles contained in the pigment dispersions used in the preparation of the respective inks (A-2), (A-3), (B-1), and (B-2) were as shown in Table 4.

<Evaluation of Image Density>

Evaluation of image density was performed under environment conditions at a temperature of 25° C. and a relative humidity of 60%. An inkjet recording apparatus (inkjet recording apparatus including a line-type recording head, test machine manufactured by KYOCERA Document Solutions Inc.) was used as an evaluation apparatus. As a recording medium, A4 size plain paper (“C²”, product of Fuji Xerox Co., Ltd.) was used. An ink (any of the inks (A-1) to (A-3), (B-1), and (B-2)) was charged into a cyan ink tank of the evaluation apparatus. The evaluation apparatus was set so that the amount of ink ejected toward the recording medium from the recording head was 11 pL per pixel. Using the evaluation apparatus, a solid image (size: 4 cm by 5 cm) was formed on the recording medium. The image density of the formed solid image was measured using a reflectance densitometer (“RD-19”, product of X-Rite Inc.) In detail, each image density at 10 randomly selected locations in the solid image was measured and an arithmetic mean of the image densities at the 10 locations was taken to be an evaluation value for image density. The evaluation values for image density were shown in the row titled “Image density” in Table 4. Based on the evaluation values for image density, image density was evaluated in accordance with the following criteria.

(Evaluation Criteria for Image Density)

Good: Image density of 1.20 or greater

Poor: Image density of less than 1.20

<Evaluation of Scratch Resistance>

An unprinted blank sheet of paper (unused paper, the same as that used in evaluation of image density) was placed on the solid image formed in <Evaluation of Image Density> described above. The solid image was rubbed back and forth 5 times over the blank sheet of paper with a 1-kg weight so as to apply only the dead weight of the weight. In order to check for color transfer from the solid image to the blank sheet of paper, the image density (color transfer density) of a part of the blank sheet that had been in contact with the solid image was measured. The color transfer density was measured by the same method as that for measuring image density described above in <Evaluation of Image Density>. An arithmetic mean of the color transfer densities at 10 locations was used as an evaluation value for color transfer density. The evaluation values for color transfer density were shown in the row titled “Scratch Resistance” in Table 4. Based on the evaluation values for color transfer density, scratch resistance was evaluated in accordance with the following criteria.

(Evaluation Criteria for Scratch Resistance)

Good: Color transfer density of no greater than 0.20

Poor (NG): Color transfer density of greater than 0.20

TABLE 4

| | Comparative | Exam- | Exam- | Exam- | Comparative |
|---|---|---|---|---|---|
| | Example 1 | ple 1 | ple 2 | ple 3 | Example 2 |
| Ink | B-1 | A-1 | A-2 | A-3 | B-2 |
| Ink formulation | 1 | 1 | 1 | 1 | 1 |
| Dispersion | A | A | A | A | A |
| formulation | | | | | |
| Resin | R-A | R-A | R-A | R-A | R-A |
| Bead diameter | 0.5 | 0.5 | 0.5 | 1.0 | 1.0 |
| [mm] | | | | | |
| Number of | 3 | 2 | 1 | 2 | 1 |
| dispersion | | | | | |
| [times] | | | | | |
| Particle | 85 | 90 | 95 | 100 | 105 |
| diameter | | | | | |
| [nm] | | | | | |
| Image density | 1.16 (NG) | 1.21 | 1.24 | 1.22 | 1.27 |
| Scratch | 0.14 | 0.17 | 0.17 | 0.19 | 0.23 (NG) |
| resistance | | | | | |

In Table 4, “Particle diameter” indicates an average particle diameter of dispersion particles. Note that each of the resin/pigment ratios of the inks in Table 4 was 0.08. Also, the repeating unit ratio of the resin (R-A) contained in each of the inks in Table 4 was 0.51.

As shown in Table 4, the average particle diameter of dispersion particles contained in the ink (B-1) was less than 90 nm. As a result, an image formed with the ink (B-1) was rated as poor in evaluation of image density as shown in Table 4.

As shown in Table 4, the average particle diameter of dispersion particles contained in the ink (B-2) was greater than 100 nm. As a result, an image formed with the ink (B-2) was rated as poor in evaluation of scratch resistance as shown in Table 4.

By contrast, each of the inks (A-1) to (A-3) had the following features. That is, the ink contained at least pigment particles, a resin, and water. As shown in Table 4, the average particle diameter of dispersion particles was at least 90 nm and no greater than 100 nm. The resin/pigment ratio was at least 0.05 and no greater than 0.10. The resin included at least the repeating units (1) and (2), and the repeating unit ratio was at least 0.35 and no greater than 0.80. As a result, images formed with the respective inks (A-1) to (A-3) were each rated as good in both evaluation of image density and evaluation of scratch resistance as shown in Table 4.

[Study of Resin/Pigment Ratio]

<Preparation of Inks (C-1) to (C-3), (D-1), and (D-2)>

Next, inks (C-1) to (C-3), (D-1), and (D-2) with different resin/pigment ratios were prepared according to the following method. The compositions of these inks are shown in Table 6. The compositions of dispersion formulations A to E in Table 6 are shown in Table 5. The ink formation 1 in Table 6 was previously shown in Table 3. Note that the dispersion formulation A was previously shown in Table 2 but is shown again in Table 5 for the sake of explanation. Furthermore, the ink (C-2) in Table 6 is the same as the ink (A-2) in Table 4 but is shown again as the ink (C-2) in Table 6 for the sake of explanation.

TABLE 5

| Dispersion formulation | | A | B | C | D | E |
|---|---|---|---|---|---|---|
| Water | [wt %] | 83.30 | 84.05 | 83.75 | 83.00 | 82.70 |
| Resin | [wt %] | 1.20 | 0.45 | 0.75 | 1.50 | 1.80 |
| Pigment | [wt %] | 15.00 | 15.00 | 15.00 | 15.00 | 15.00 |
| Olfine | [wt %] | 0.50 | 0.50 | 0.50 | 0.50 | 0.50 |
| Total | [wt %] | 100.00 | 100.00 | 100.00 | 100.00 | 100.00 |

TABLE 6

| | Comparative | Exam- | Exam- | Exam- | Comparative |
|---|---|---|---|---|---|
| | Example 3 | ple 4 | ple 5 | ple 6 | Example 4 |
| Ink | D-1 | C-1 | C-2 | C-3 | D-2 |
| Ink formulation | 1 | 1 | 1 | 1 | 1 |
| Dispersion | B | C | A | D | E |
| formulation | | | | | |
| Resin | R-A | R-A | R-A | R-A | R-A |
| Resin/pigment | 0.03 | 0.05 | 0.08 | 0.10 | 0.12 |
| ratio | | | | | |
| Image density | 1.24 | 1.21 | 1.24 | 1.21 | 1.17 (NG) |
| Scratch | 0.24 (NG) | 0.18 | 0.17 | 0.17 | 0.14 |
| resistance | | | | | |

In (Pigment Dispersion Preparation) in <Preparation of Ink (A-1)> described above, the inks (C-1) to (C-3), (D-1), and (D-2) were prepared according to the same method as that for preparing the ink (A-1) in all aspects other than that the ratio indicated in Dispersion formulation A in Table 2 was changed to the ratios indicated in the respective columns titled Dispersion formulations A to E in Table 5 and the number of dispersion was changed from 2 to 1. In preparation of the inks (C-1) to (C-3), (D-1), and (D-2), the resin (R-A) was used as “Resin” Dispersion formulations A to E in Table 5.

The average particle diameters of the dispersion particles contained in the respective inks (C-1) to (C-3), (D-1), and (D-2) in Table 6 each were 95 nm. The resin/pigment ratios of the inks (C-1) to (C-3), (D-1), and (D-2) were as shown in Table 6. Furthermore, the repeating unit ratio of the resin (R-A) contained in each of the inks in Table 6 was 0.51.

<Evaluation of Inks (C-1) to (C-3), (D-1), and (D-2)>

With respect to each of the obtained inks (C-1) to (C-3), (D-1), and (D-2), image density and scratch resistance were evaluated by the same methods as those described above in <Evaluation of Image Density> and <Evaluation of Scratch Resistance>. The evaluation results are shown in Table 6.

As shown in Table 6, the ink (D-1) had a resin/pigment ratio of less than 0.05. As a result, an image formed with the ink (D-1) was rated as poor in evaluation of scratch resistance as shown in Table 6.

As shown in Table 6, the ink (D-2) had a resin/pigment ratio of greater than 0.10. As a result, an image formed with the ink (D-2) was rated as poor in evaluation of image density as shown in Table 6.

By contrast, each of the inks (C-1) to (C-3) had the following features. That is, the ink contained at least pigment particles, a resin, and water. The dispersion particles had an average diameter of at least 90 nm and no greater than 100 nm. As shown in FIG. 6, the resin/pigment ratio was at least 0.05 and no greater than 0.10. The resin included at least the repeating units (1) and (2), and the repeating unit ratio was at least 0.35 and no greater than 0.80. As a result, images formed with the respective inks (C-1) to (C-3) were each rated as good in evaluation of image density and evaluation of scratch resistance as shown in Table 6.

[Study of Repeating Unit Ratio of Resin and Type of Resin]

Next, inks (E-1), (E-2), (F-1), and (F-2) containing resins with different repeating unit ratios and an ink (F-3) containing a resin different from a styrene-maleic anhydride copolymer were prepared according to the following method. The compositions of these inks are shown in Table 9 below.

<Preparation of Inks (E-1), (E-2), and (F-1) to (F-3)>

(Preparation of Resins (R-1) to (R-4))

First, resins (R-1) to (R-4) were prepared. The compositions of the resins (R-1) to (R-4) are shown in Table 7.

TABLE 7

| | ST-MA | | | | | Surface |
|---|---|---|---|---|---|---|
| | copolymer | 1-Butanol | 2-Propanol | Ethanol | Unit | tension |
| Resin | [part] | [part] | [part] | [part] | ratio | [mN/m] |
| R-1 | 90 | 10 | — | — | 0.23 | 43 |
| R-2 | 85 | 15 | — | — | 0.37 | 40 |
| R-3 | 80 | 20 | — | — | 0.53 | 35 |
| R-4 | 70 | 30 | — | — | 0.90 | 33 |

The resins (R-1) to (R-4) were prepared according to the same method as that for preparing the resin (R-A) in all aspects other than that the amount of the styrene-maleic anhydride copolymer was changed from 82 parts to those shown in Table 7 and the amount of 1-butanol was changed from 18 parts to those shown in Table 7. The repeating unit ratios and the resin surface tensions of the resins (R-1) to (R-4) are shown in Table 7.

(Ink Preparation)

The compositions of the inks (E-1), (E-2), and (F-1) to (F-3) are shown in Table 9. The dispersion formulation A in Table 9 was previously shown in Tables 2 and 5. The ink formation 2 in Table 9 is shown in Table 8.

TABLE 8
Ink formulation 2

| | | |
|---|---|---|
| Pigment dispersion | [wt %] | 40.0 |
| Triethylene glycol monobutyl ether | [wt %] | 3.0 |
| 2-Pyrrolidone | [wt %] | 7.0 |
| 1,3-Propanediol | [wt %] | 18.0 |
| Olfine | [wt %] | 0.2 |
| Water | [wt %] | Rest |
| Total | [wt %] | 100.0 |

TABLE 9

| | Compar- | | | Compar- | Compar- |
|---|---|---|---|---|---|
| | ative | Exam- | Exam- | ative | ative |
| | Example 5 | ple 7 | ple 8 | Example 6 | Example 7 |
| Ink | F-1 | E-1 | E-2 | F-2 | F-3 |
| Ink | 2 | 2 | 2 | 2 | 2 |
| formulation | | | | | |
| Dispersion | A | A | A | A | A |
| formulation | | | | | |
| Resin | R-1 | R-2 | R-3 | R-4 | Styrene |
| | | | | | acrylic |
| Unit ratio | 0.23 | 0.37 | 0.53 | 0.90 | — |
| Image | 1.21 | 1.22 | 1.21 | 1.17 (NG) | 1.22 |
| density | | | | | |
| Scratch | 0.24 (NG) | 0.18 | 0.16 | 0.13 | 0.33 (NG) |
| resistance | | | | | |

In table 9, “Styrene acrylic” indicates a styrene-acrylic resin SA (a copolymer of methacrylic acid (MAA), methyl methacrylate (MMA), butyl acrylate (BA), and styrene (ST), molar ratio (MAA:MMA:BA:ST)=30:20:20:30, mass average molecular weight 20,000). The styrene-acrylic resin SA had a resin surface tension of 45 mN/m.

The inks (E-1), (E-2), and (F-1) to (F-3) were prepared according to the same method as that for preparing the ink (A-1) in all aspects other than that the resin (R-A) described above in (Pigment Dispersion Preparation) in <Preparation of Ink (A1)> was changed to those shown in Table 9 and the ratio of the ink formation 1 in Table 3 described above in (Ink Preparation) in <Preparation of Ink (A-1)> was changed to those shown in Ink formulation 2 in Table 8.

Each of the resin/pigment ratios of the inks (E-1), (E-2), and (F-1) to (F-3) was 0.08. Each of the average particle diameters of the dispersion particles contained in the respective inks was 90 nm. Furthermore, the resins contained in the respective resins (E-1), (E-2), (F-1), and (F-2) (specifically, resins (R-1) to (R-4)) had the repeating unit ratios shown in Table 9. The styrene-acrylic resin contained in the ink (F-3) included neither the repeating unit (1) nor the repeating unit (2), and therefore, the repeating unit ratio thereof was not able to be calculated.

<Evaluation of Inks (E-1), (E-2), and (F-1) to (F-3)>

With respect to each of the obtained inks (E-1), (E-2), and (F-1) to (F-3), image density and scratch resistance were evaluated by the same methods as those described above in <Evaluation of Image Density> and <Evaluation of Scratch Resistance>. The evaluation results are shown in Table 9.

As shown in Table 9, the repeating unit ratio of the resin contained in the ink (F-1) was less than 0.35. As a result, an image formed with the ink (F-1) was rated as poor in evaluation of scratch resistance as shown in Table 9. The reason for reduced scratch resistance is thought to be that as shown in Table 7, the resin surface tension of the resin (R-1) is higher than that of the predetermined resin with a repeating unit ratio of at least 0.35 and no greater than 0.80.

As shown in Table 9, the repeating unit ratio of the resin contained in the ink (F-2) was greater than 0.80. As a result, an image formed with the ink (F-2) was rated as poor in evaluation of image density as shown in Table 9. The reason why the image density was lower than a desired value is thought to be that as shown in Table 7, the resin surface tension of the resin (R-4) is lower than that of the predetermined resin with a repeating unit ratio of at least 0.35 and no greater than 0.80.

As previously described, the styrene-acrylic resin contained in the ink (F-3) included neither the repeating unit (1) nor the repeating unit (2). As a result, an image formed with the ink (F-3) was rated as poor in evaluation of scratch resistance as shown in Table 9. The reason for reduced scratch resistance is thought to be that the resin surface tension of the styrene acrylic resin is higher than that of the predetermined resin including the repeating units (1) and (2).

By contrast, each of the inks (E-1) and (E-2) had the following features. That is, the ink contained at least pigment particles, a resin, and water. The dispersion particles had an average particle diameter of at least 90 nm and no greater than 100 nm. The resin/pigment ratio was at least 0.05 and no greater than 0.10. As shown in Table 9, the resins (specifically, the resins (R-2) and (R-3)) each included at least the repeating units (1) and (2) and the repeating unit ratio thereof was at least 0.35 and no greater than 0.80. As a result, images formed with the respective inks (E-1) and (E-2) were each rated as good in evaluation of image density and evaluation of scratch resistance as shown in Table 9.

[Study of Alcohol for Half Esterification Used for Resin Preparation]

Subsequently, inks (G-1), (G-2), and (H-1) containing resins prepared using different alcohols for half esterification were prepared by the following method. The compositions of these inks are shown in Table 11 below.

<Preparation of Inks (G-1), (G-2), and (H-1)>

(Preparation of Resins (R-5) to (R-7))

First, resins (R-5) to (R-7) were prepared. The compositions of the resins (R-5) to (R-7) are shown in Table 10.

TABLE 10

| | ST-MA | | | | | Surface |
|---|---|---|---|---|---|---|
| | copolymer | 1- Butanol | 2- Propanol | Ethanol | Unit | tension |
| Resin | [part] | [part] | [part] | [part] | ratio | [mN/m] |
| R-5 | 70 | — | 30 | — | 0.74 | 35 |
| R-6 | 80 | — | 20 | — | 0.76 | 38 |
| R-7 | 80 | — | — | 20 | 0.56 | 45 |

The resins (R-5) to (R-7) were prepared according to the same method as that for preparing the resin (R-A) in all aspects other than that the amount of the styrene-maleic anhydride copolymer was changed from 82 parts to those shown in Table 10 and 18 parts of 1-butanol was changed to alcohols for half esterification (specifically, 2-propanol or ethanol) in amounts shown in Table 10. The repeating unit ratios and the resin surface tensions of the resins (R-5) to (R-7) are shown in Table 10.

(Ink Preparation)

The compositions of the inks (G-1), (G-2), and (H-1) are shown in Table 11. The dispersion formulation A in Table 11 is already shown in Tables 2 and 5. The ink formation 2 in Table 11 was previously shown in Table 8.

TABLE 11

| | | | Comparative |
|---|---|---|---|
| | Example 9 | Example 10 | Example 8 |
| Ink | G-1 | G-2 | H-1 |
| Ink formulation | 2 | 2 | 2 |
| Dispersion formulation | A | A | A |
| Resin | R-5 | R-6 | R-7 |
| Alcohol for half | 2-Propanol | 2-Propanol | Ethanol |
| esterification | | | |
| Image density | 1.23 | 1.23 | 1.24 |
| Scratch resistance | 0.16 | 0.17 | 0.22 (NG) |

The inks (G-1), (G-2), and (H-1) were prepared according to the same method as that for preparing the ink (A-1) in all aspects other than that the resin (R-A) was changed to resins shown in Table 11 in (Pigment Dispersion Preparation) in <Preparation of Ink (A-1)> described above and the ratio of the ink formulation 1 in Table 3 was changed to those shown in Ink formulation 2 in Table 8 in (Ink Preparation) of <Preparation of Ink (A-1)> described above.

The inks (G-1), (G-2), and (H-1) each had a resin/pigment ratio of 0.08. The average particle diameter of the dispersion particles contained in each of the respective inks was 90 nm. The repeating unit ratios of the resins (specifically, the resins (R-5) to (R-7)) contained in the respective inks (G-1), (G-2), and (H-1) were as shown in Table 10.

<Evaluation of Inks (G-1), (G-2), and (H-1)>

With respect to each of the obtained inks (G-1), (G-2), and (G-1), image density and scratch resistance were evaluated by the same methods as those described above in <Evaluation of Image Density> and <Evaluation of Scratch Resistance>. The evaluation results are shown in Table 11.

As shown in Table 11, the resin (R-7) contained in the ink (H-1) was half-esterified using ethanol, and therefore was a resin having a alkyl group having a carbon number of 2 represented by R¹ in formula (2). As a result, an image formed using the ink (H-1) was rated as poor in evaluation of scratch resistance as shown in Table 11. The reason for the decrease in scratch resistance is thought to be that the resin surface tension of resin (R-7) is higher than that of the predetermined resin having an alkyl group having a carbon number of 3 or 4 represented by R¹ in formula (2) as shown in Table 10.

By contrast, each of the inks (G-1) and (G-2) had the following features. That is, the ink contained at least pigment particles, a resin, and water. The dispersion particles had an average particle diameter of at least 90 nm and no greater than 100 nm. The resin/pigment ratio was at least 0.05 and no greater than 0.10. As shown in Table 10, the resins (specifically, the resins (R-5) and (R-6)) each included at least the repeating units (1) and (2) and the repeating unit ratio was at least 0.35 and no greater than 0.80. As a result, images formed with the respective inks (G-1) and (G-2) were each rated as good in both evaluation of image density and evaluation of scratch resistance as shown in Table 11.

From the above, it has been shown that use of the ink according to the present disclosure, which encompasses the inks (A-1) to (A-3), (C-1) to (C-3), (E-1), (E-2), (G-1), and (G-2), can achieve formation of images with high image density and excellent scratch resistance even when no processing solution is used in combination.

What is claimed is:

1. An inkjet ink comprising:
at least pigment particles, a resin, and water, wherein
dispersion particles in the inkjet ink including the pigment particles have an average particle diameter of at least 90 nm and no greater than 100 nm,
the resin has a mass ratio to the pigment particles of at least 0.05 and no greater than 0.10,
the resin includes at least a repeating unit represented by formula (1) and a repeating unit represented by formula (2), and
a molar ratio of the repeating unit represented by the formula (2) to the repeating unit represented by the formula (1) is at least 0.35 and no greater than 0.80, 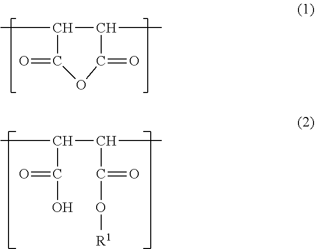
where in the formula (2), R¹ represents an alkyl group having a carbon number of 3 or 4.

2. The inkjet ink according to claim 1, wherein
the resin further includes a repeating unit derived from a compound having a styrene skeleton.

3. The inkjet ink according to claim 1, wherein
an aqueous solution of the resin has a surface tension of at least 35 mN/m and no greater than 40 mN/m at a concentration of 10% by mass.

4. The inkjet ink according to claim 1, wherein
at least a portion of the resin is attached to surfaces of the pigment particles, and
the dispersion particles each are a particle including one of the pigment particles and the resin attached to a surface of the pigment particle.
